(19) United States
(12) Patent Application Publication
(10) Pub. No.: US 2002/0036430 A1
(43) Pub. Date: Mar. 28, 2002

(54) Local area grid for distributed power

(76) Inventors: Richard S. Welches, Amherst, NH (US); Richard E. Griessel, Derry, NH (US); Jian Wen, North Andover, MA (US)

Correspondence Address: MAINE & ASMUS, 100 MAIN STREET, P O BOX 3445, NASHUA, NH, 03061-3445, US

(21) Appl. No.: 09/966,241

(22) Filed: Sep. 28, 2001

Related U.S. Application Data
(60) Provisional application No. 60/236,268, filed on Sep. 28, 2000.

(51) Int. Cl. H02J 3/00

(52) U.S. Cl. 307/18

(57) ABSTRACT

The invention in the simplest form is a system for managing distributed power sources connected to a power grid. The present invention manages power flow to/from the power grid whether for a stand-alone power sourece or for local area utility grid or microgrid. When two or more power sources are interconnected by the local grid, each source has a power conditioning unit and a circuit breaker manager for controlling and regulating the electric flow to/from the grid. The individual power sources are able to independently draw power from the grid when required without extensive master control schemes. In a preferred embodiment the power sources are reformer equipped fuel cells and the heat from the fuel cell is used as a heat source for efficiency.

### CROSS REFERENCE TO RELATED APPLICATIONS

This application claims priority under 35 U.S.C. Section 120 from a U.S. Provisional Patent Application Ser. No. 60/236,268 filed on Sep. 28, 2001, which is incorporated herein by reference for all purposes.

### BACKGROUND OF THE INVENTION

1. Field of the Invention

The present invention relates to power distribution. More specifically, the present invention relates power distribution within a local area grid or microgrid.

2. Background Art

The distribution of electric power has predominantly been done using large centralized grids. These large grids connect power plants and substations with existing homes and provide a relatively stable power source. These large grids have a number of disadvantages, including reliance upon certain vital connections that connect to inefficient power plants as well as distribution difficulties during peak demands. There are schemes for load shaving the centralized grid in order to diminish the peak power difficulties. The centralized grids also suffer from inherent inefficiencies in delivering power because of the grid network losses itself and the extensive array of interconnections.

The distribution of electric power from utility companies to households and businesses utilizes a network of utility lines connected to each residence and business. The centralized network or grid is interconnected with various generating stations and substations that supply power to the various loads and that monitor the lines for problems.

A centralized electric utility grid generally can also consist of many independent energy sources energizing the grid and providing power to the loads on the grid. This distributed power generation is becoming more common throughout the world as alternative energy sources are being used for the generation of electric power. Distributed electric power generation (e.g. converting power from photovoltaics, micro-turbines, or fuel cells at customer sites) functions in conjunction with the grid. However, large scale integration of these power sources is not yet feasible because there needs to be an interface between the centralized grid and the power source to regulate the power from/to the grid and a means of monitoring the activity.

In the United States, the deregulation of electric companies has spurred the development of independent energy sources co-existing with the electric utility. Rather than have completely independent energy sources for a particular load, these alternative energy sources can tie into the grid and are used to supplement the capacity of the electric utility to avoid peak load problems. Theoretically such a system is possible, but the implementation has not met with much success.

The number and types of independent energy sources is growing rapidly, and includes photovoltaics, wind, hydro, fuel cells, storage systems such as battery, super-conducting, flywheel, and capacitor types, and mechanical means including conventional and variable speed diesel engines, Stirling engines, gas turbines, and micro-turbines. In many cases these energy sources can sell the utility company excess power from their source that is utilized on their grid.

One of the most promising areas of power generation is fuel cells. There are many advantages to fuel cells, including having highly efficient power units that rely on Hydrogen instead of fossil fuels and generate water as a waste product. Once these units are more popular, for both homes and transportation, the reliance on the oil will diminish. Moreover, the fuel cells do not pollute anywhere near the amounts of internal combustion engines per kilowatt hour generated even when fed hydrogen derived from hydrocarbon fuels.

A fuel cell operates in a similar fashion to a battery, but unlike a battery, a fuel cell does not run down or require recharging. The fuel cell produces energy in the form of electricity and heat, provided the fuel supply is present. Physically, a fuel cell has two electrodes sandwiched around an electrolyte. As oxygen passes over one electrode and hydrogen over the other, electricity, water and heat are generated in a highly efficient manner.

The fuel supply of a fuel cell is hydrogen. Hydrogen is fed into the anode of the fuel cell, while oxygen/air enters the fuel cell via the cathode. A catalyst is used to promote the splitting of the hydrogen atom into a proton and an electron. The proton and the electron take different routes to the cathode, where they are combined with the hydrogen and oxygen in a molecule of water. The proton passes through the electrolyte, while the electron creates a separate current before returning to the cathode.

An advantage of the reformer equipped fuel cell is that it uses hydrogen from any hydrocarbon fuel, including natural gas, methanol, and gasoline. The fuel cells are more efficient that combustion engines because the fuel cell relies on electro-chemical processes as opposed to thermal processes. The emissions from the fuel cell are much lower than emissions from the most efficient combustion process. And, the interconnecting of these power units increases the amount of electricity output.

Although the large scale integration of distributed power sources holds much promise, the interconnection and management of a decentralized local grid power has difficulties in maintaining proper grid voltage with so many power sources connected. The centralized system does not require a comprehensive power management scheme as there are enough sources connected to the large grid that there is always enough power available except in extreme emergency. A smaller local area grid with proper power management with suitable control and regulation to the centralized grid is a possible solution to large scale applicability.

In order to reduce the aforementioned problems, attempts have been made to produce a system to integrate a local area grid. The prior art systems have general short-comings and do not adequately address the aforementioned problems.

In U.S. Pat. No. 5,767,584, ('584) a forward thinking patent discusses using parked vehicles with fuel cells as a potential power source. While this general concept is possible, the '584 invention does not discuss the connectivity and regulation aspects of connecting these multiple power sources to a local grid.

A load control scheme is shown in U.S. Pat. No. 4,437,575 ('575) wherein a master control station communicates with substations using encoded signals on the power lines for controlling certain functions such as connecting or disconnecting certain paths.

A power system with communications protocol between a host computer and power sources is described in U.S. Pat. No. 6,055,163. This system uses a separate communications line between the host computer and the power sources, wherein the host computer issues power level commands and power factor to the remote power sources.

What is needed is system for regulating a decentralized local grid that manages electrical and heat requirements for all connections to the local grid. The microgrid should allow for an efficient use of resources for the entire grid by controlling the individual power generators. Safety and reliability should be a benchmark of such a system and there should be mechanisms for administering the electrical power distribution for grids ranging from a single household to numerous households and buildings.

### SUMMARY OF THE INVENTION

The present invention has been made in consideration of the aforementioned background. One object of the present invention is an electrical energy management system to connect two or more electrical producing power sites to a local area grid. A local area grid (LAG) is a grid that interconnects two or more power conditioning units (PCU's) via a power cable. The electrical power source is directly correlated to the individual load demand in such a manner that the management scheme can draw from any other power site within the local grid without employing a master control scheme.

In one embodiment the management and control scheme maintains a power setting at the power site as close to the predetermined setting as possible. The more power sites that are connected in parallel, the closer the management scheme is able to maintain the individual power setting even under extreme individual demands.

In a preferred embodiment the power generation site also produces heat, such as from a fuel cell. An electrical and heat management system is used to manage and control the heat and energy of a power site on a local area grid. The electrical power source and temperature control are directly correlated to the individual load demand in such a manner that the management scheme can draw from any other power site within the local grid without employing a master control scheme.

In one embodiment the management and control scheme maintains a temperature and/or power setting at the power site as close to the predetermined setting as possible. The more power sites that are connected in parallel, the closer the management scheme is able to maintain the individual settings even under extreme individual demands.

The power site is used to convert prime energy into electrical power, preferably in an efficient manner. The electrical output of the power site is connected to a power conditioning unit (PCU). The PCU converts the electrical output of the power site to a filtered and regulated standard AC output.

In one embodiment, an electrical storage device such as a battery is connected to the input of the PCU, wherein the battery can store excess electrical output. The battery can then be used during peak demand periods or during start-up.

The output of the PCU may be connected to the local area grid (LAG) via a circuit breaker manager (CBM). The CBM is comprised of intelligent circuit breakers that are solid state devices. Theses solid state devices are used not only to shutoff a short circuit condition, but also to soft start motors or shed load to reduce peak power demands. The W1C configuration is essentially parallel thyristors that are opposingly connected such that current can flow in either direction, and are controlled by the CBM.

A further object of the invention is to enable various prior art concepts, such as soft start, load sharing, and load shaving. The soft start (less than full cycle conduction period) function of the thyristors can be used to shut off and then gradually ramp up individual branch circuits, thereby limiting current overloads. Load sharing is splitting a load between two or more power sources while preventing back feed. Load shaving can be defined as disabling non-essential branch circuits that would otherwise cause a system overload fault.

The CBM can also encompass phase angle detectors and LAG voltage detectors in order to monitor LAG requirements. A more comprehensive description of the detection schemes is contained herein.

A communications interface is required to provide access and control of the grid and the power sites and allow for administrative functions such as tracking input/output electricity, remotely adjust parameters of the PCU, turn feeders on/off, monitoring and alerting for maintenance, and billing. In a preferred embodiment the Internet is used for the communications, and a modem is installed as part of the CBM. In one embodiment, the owner of each PCU or CBM has access to an Internet server to determine status of the operation and billing, as well as the ability to adjust parameters. Security via password or other means is well within the scope of the invention.

A further object of the invention is a Circuit Breaker Manager (CBM), which is an intelligent circuit breaker scheme that directly replaces the existing circuit breaker box and offers more functionality. It also works with fuel cell power systems by providing AC back feed protection, energy management and Internet connectivity. The intelligent CBM comprises a controller, plurality of thyristor circuit breakers, contactors, RF filter, an RF modulator, and a multi-thyristor gate driver.

An object is a distributed power system for a utility grid, comprising a distributed power source, a temperature measuring device, a power conditioning unit, wherein the power conditioning unit manages a power flow of the distributed power source, and a circuit breaker manager controllably connecting to the power grid, wherein the circuit breaker manager is connected to the power conditioning unit.

Another object is the distributed power system, further comprising a heat exchanger for recovering heat from the distributed power source. Also, the distributed power system, wherein the circuit breaker manager controllably connects individual load branches. Further, the distributed power system for a utility grid, wherein the utility grid is a local area grid comprising a plurality of distributed power sources.

An object is a segmentable distributed power system, comprising two or more power sources connected in parallel, with a power conditioning unit having an output impedance and connecting to each of the power sources on a first side and connecting to a shared load on a second side, wherein the power conditioning system controls the output impedance.

Another object is a circuit breaker manager for controlling distributed power between a power source and an external power grid, comprising a circuit breaker controller, a plurality of solid state branch circuit breakers controlled by the circuit breaker controller, a contactor for connecting to the external power grid, a voltage sensor for measuring the external power grid, and a means for communicating. Additionally, wherein the communicating means connects to the Internet, and further comprising an interface means for connecting said power conditioning unit to a graphical user interface for status, billing, maintenance, and adjustment of system parameters.

An object is a method for controlling a local area grid, wherein the grid contains two or more distributed power sources, comprising the steps of measuring a grid voltage by each power condition unit, comparing said grid voltage of each power conditioning unit to a predetermined value, increasing current output of the power conditioning unit to the local area grid if the grid voltage is less than the predetermined value, decreasing current output of the power conditioning unit to the local area grid if the grid voltage is greater than the predetermined value.

An object includes a distributed power system for a ripple sensitive distributed power source, comprising a DC-DC converter serially connecting to the ripple sensitive power source on a first side, a ripple tolerant power source connecting to the DC-DC converter on a second side, a phase shifted H-bridge connecting to the second side of the DC-DC converter on a first side, a DC-AC converter connecting to a second side of the H-bridge, and a means for forcing ripple sourced from the ripple tolerant power source.

Other objects, features and advantages are apparent from description in conjunction with the accompanying drawings.

### BRIEF DESCRIPTION OF THE FIGURES

The present invention will be readily understood by the following detailed description in conjunction with the accompanying drawings, wherein like reference numerals designate like structural elements, and in which:

FIG. 1: top level diagram showing the microgrid or local area grid interconnection of several houses using distributed power sources

FIG. 2: shows the PCU inverter electrical power control loop and the inner voltage loop and outer current loop

FIG. 3: shows a further PCU inverter control loop incorporating a slew control for detection of grid impedance and power flow

FIG. 4: illustrates parallel sources to a shared load with controlled output impedances

FIG. 5A: a stand-alone volts loop with parallel current limit loop control loop

FIG. 5B: a stand-alone parallel voltage and current control loop timing diagram

FIG. 6: a further diagrammatic view of the distributed power system showing the interconnections of the fuel cell, PCU, CBM and grid

FIG. 7: block diagram of the CBM components and the external connections

FIG. 8: schematic of thyristor circuit breaker control circuitry

FIG. 9: block diagram of the HF topology and the connecting elements

FIG. 10: schematic of the buck into the battery or boost from battery

FIG. 11: PCU power switch equivalent circuit

FIG. 12: Optimized heat recovery/battery charge control loop

### DESCRIPTION OF THE PREFERRED EMBODIMENT

The foregoing description of the preferred embodiment of the invention has been presented for the purpose of illustration and description. It is not intended to be exhaustive or to limit the invention to the precise form disclosed. Many modifications and variations are possible in light of the above teachings. It is intended that the scope of the invention be limited not by this detailed description, but rather by the claims appended hereto.

All known power generation technologies create waste heat. In a distributed power microgrid this generated heat can be effectively “distributed” throughout the microgrid such that local generation nodes where excess heat is required, generate proportionally more electrical power to the microgrid than nodes that do not require local heat. In effect, this control method produces distributed power generation related inefficiencies (heat) where it can be most effectively “recovered”. Increasing overall microgrid connected system efficiency for the entire grid.

For example, a housing development that is supplied natural gas for heating as well as for use in distributed power fuel cell power generator systems. Houses with the greatest demand for heat (air or water) would generate proportionally more electrical power to recover and use generator inefficiencies for heat while metering power export to the micro grid. This type of control allows for less gas to be burned locally for heat, and increases overall system efficiency reducing natural gas demand system wide.

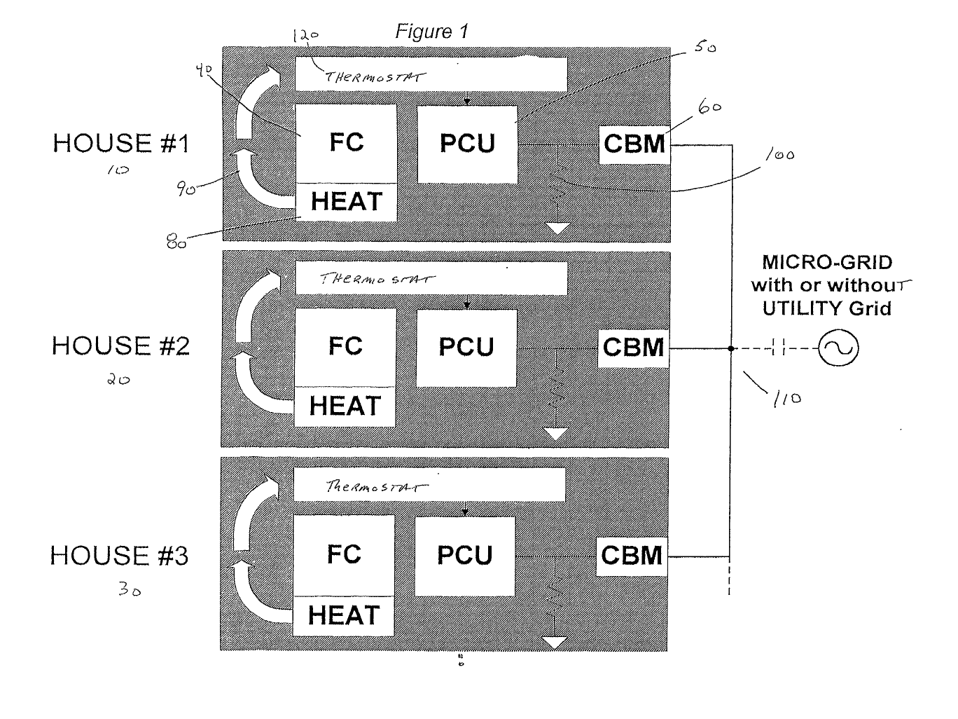

Referring to FIG. 1, a top-level depiction of the elements of a preferred embodiment is disclosed. In this embodiment, one or more houses 10, 20, 30 are interconnected via a local area grid or microgrid 110. Each home 10, 20, 30 on the utility grid 110 would have a fuel cell 40 or other power generation system to generate electricity. The grid 110 allows the individual homes 10, 20, 30 to take power from the grid 110 or to export power to the grid 110.

The fuel cell 40 connects to the Power Conditioning Unit (PCU) 50 that filters, regulates, and controls the output of the fuel cell 40. The PCU 50 is comprised of a power conditioning system, a power detection section, an auxiliary power supply, and a communications section. In one embodiment the communications section is an Internet modem. The modem connects to a phone line and allows external or remote access. Obviously other communication interfaces are within the scope of the invention, including a cable modem with cable connection, a network card with a T1 or DSL/ADSL connection, as well as a wireless interface card. A battery is connected to the PCU in the preferred embodiment.

The PCU 50 interconnects with the CBM 60, wherein the CBM 60 comprises a load shaver, a circuit breaker scheme, a detector section, and an Internet or wireless communication device, such as a modem. The CBM 60 is responsible for the ultimate connection to the grid 110, so the control and ability to isolate power very quickly is important.

The CBM 60 can meter power output (or input) for billing purposes. It can directly replace existing circuit breaker boxes or function as an interface to the existing breakers. The CBM 60 has added benefits by providing back feed protection, energy management and connectivity capability such as Internet and wireless transmissions.

Each house 10, 20, 30 has a load 100 that represents the electrical requirements at any given time. The greater the load 100, the greater the amount of electricity required for that house 10, 20, 30. At any given time, each house has the option of generating more electricity from the fuel cell 40 to export to the grid or taking electricity from the grid 110.

A by-product of the fuel cell 40 is heat 90, and a heat exchanger 80 is used to disperse the heat 90 throughout the house 10. This heat transfer scheme of the present invention takes advantage of the heat 90 dissipated by the fuel cell 40 during operation. The heat exchanger 80 is used to provide a heat source that may be controlled or regulated by a thermostat 120. If there is no requirement for heat, the heat exchanger 80 merely allows the heat 90 to dissipate or vented to the outside. There are other connections to the fuel cell 40, namely a vent for any fumes and a discharge path for waste water. The vent can be effectively structured to extract heat as is known to those skilled in the art of heat recovery. The water from the fuel cell can also be used for a heating source. There are various hybrid heating systems that use hot water with heat exchangers to supply house heat as well as conventional forced hot water heating systems. There are also many varieties of hot water heaters that be modified to accept the heat generated by the fuel cell 40.

Combining the electrical requirements for the grid 110 with the temperature requirements of each house 10, 20, 30, the overall grid efficiency is enhanced. A house 10 that requires more heat 90, as indicated by the thermostat 120, will coordinate with the rest of the grid 110 to use its fuel cell 40 to generate more electricity and more heat 90, and the additional electricity can be exported to the grid 110.

In this embodiment, the PCU 50 and optional circuit breaker management (CBM) 60 take the primary output command from the thermostat error. The waste heat from the fuel cell system 40 is roughly proportional to the power output. This “waste” heat can be recovered and used to augment primary house heating system (furnace or boiler) or used to make hot water.

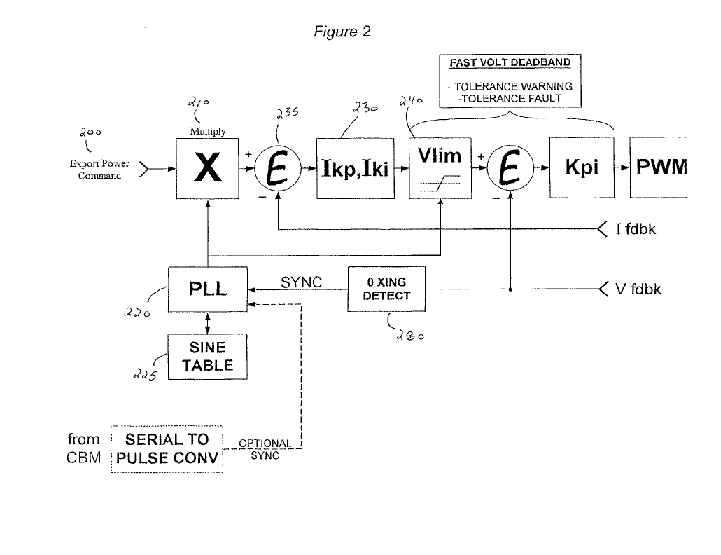

The Grid-Tie or Current Source Mode with phase lock loop (PLL) is shown in FIG. 2 with reference to FIG. 1. The export power command 200, which can be a current reference command or a temperature command signal is combined via a multiplier 210 with a sinusoidal signal from a phase lock loop circuit 220 in coordination with the sine table 225. An error signal 235 is generated and the gain stage 230 outputs a voltage command that represent the current error to the voltage limiter section 240. The voltage limiter 240 provides a band of operating limits about which the current error signal is limited.

In grid-tie mode (G/T), the PCU synchronizes to the utility voltage with the zero crossing detector 280. The current reference command is then phase locked to the utility voltages. The current reference is from a sine look-up table 225 where the pointer is offset for phase locking purposes. Alternatively, the utility line voltage feedback (Vfdbk) could serve as the current reference, although this is inferior to the look-up table method. Thus, the present system can use the current reference sinusoidal look-up table to provide sinusoidal current to the grid.

The local area grid or microgrid 110 must maintain the voltage within limits, regardless of the temperature error command from house thermostat. Where the total electrical load in the above example is, for example, above 10 KW, during the winter the need for waste heat will vary from house to house. It is beneficial to generate the bulk of the grid power in the location where the temperature error is the highest, while the electrical energy generated is then fed to the other households and their local generation of power is scaled back. In other words, they look like power consumers to the local area grid. During warmer weather, such as Summer, the local heat produced would be excessive and vented. It is to the advantage of the homeowner to limit local generation so as little energy is wasted (vented) as possible. The particulars of the processing are described herein.

The present invention uses a PI control loop comprising an inner voltage loop (with optional current loop) with an “outer” temp error loop. The inner control loop maintains electrical power within limits, but is driven by an outer loop that causes export of electrical power to the microgrid when excess heat is required, or can reduce power generated locally and allow import of microgrid power when excess heat is not desired. In addition, this method limits the import or export of electrical power, regardless of the temp error when the local voltage node (connection to the microgrid) falls outside the parameter selected tolerance band, thereby assuring microgrid stability.

In one embodiment the implementation is accomplished by allowing individual power sources to independently establish desired power import/export setpoints (temp error). Alternatively, the system can allow communication between individual distributed power sources (with or without) an overall master controller such that overall distributed power system stability and efficiency is optimized.

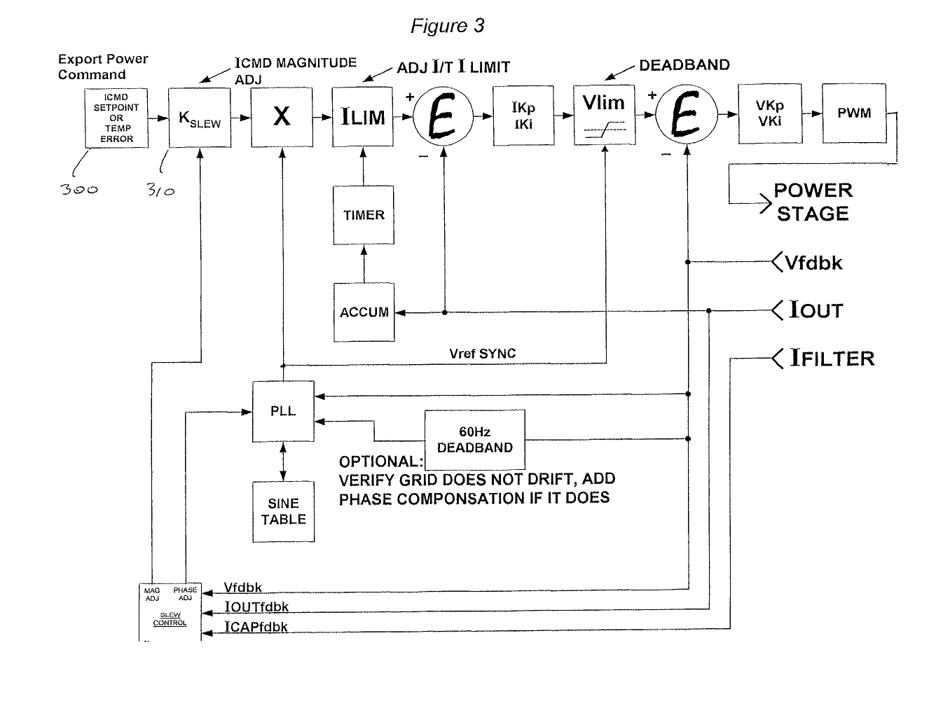

Another embodiment of the control loops of the present invention is shown in FIG. 3. The export current command or temperature error signal 300 is the primary command. This signal can come from a parameter for current setpoint or the temperature error command from the house thermostat can be utilized. The signal 300 is slewed 310 by introducing slight variations of phase and magnitude while observing line loss, power flow, etc.

An additional RMS/Average or Slow deadband loop may be run in parallel with the Fast voltage deadband loop. This auxiliary loop would have tighter tolerance thresholds but would be insensitive to fast “glitches”. This loop would adjust the current command to keep the local grid node within tighter tolerance.

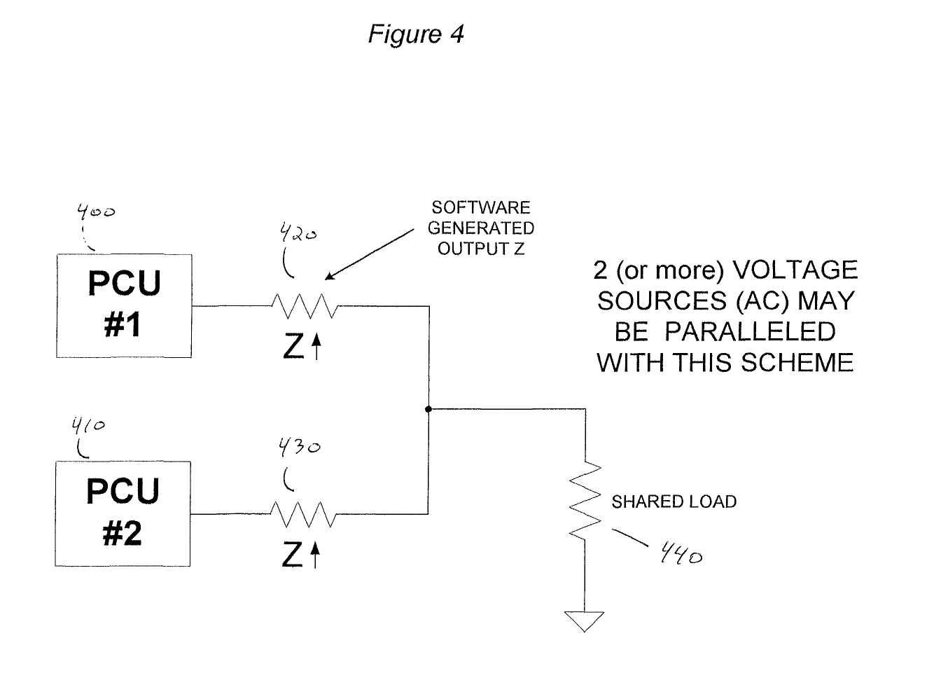

FIG. 4 illustrates the paralleling scheme for varying the output impedance. The output of a first PCU 400 has a first impedance 420 and the output of a parallel second PCU 410 and second impedance 430 are connected to a shared load 440. By controlling the output impedance of the first and second load using a deadband scheme as described herein, the voltage sources are reliably paralleled. This deadband scheme involves placing a band around the waveform and varying the first and second output impedances to maintain the optimal state. The CBM is used to monitor the current and voltage phase angles and power flow at the grid connected node.

While stand-alone and limited number of power sources have some complexity, in order to manage multiple parallel power sources a centralized control and communications is normally required. In typical distributed power architectures where paralleling is required, a single volt source controller provides a current error signal to X number of current slaves. Ideal voltage sources have low output impedances and tend to cause very unstable currents when paralleled. Ideal current sources have high output impedance and tend to cause stable currents when paralleled, but have very poor voltage regulation (stability).

The typical voltage master (outer loop) that distributes current error commands to X number of parallel current sources is difficult to scale (system wide). In addition, distributed power sources that are separated by some distance (parasitic Z) will suffer from poor local node voltage stability and phase displacement problems. These limitations inherently limit the maximum physical size of a microgrid.

To solve the problems of the prior art, the present invention seeks to provide an electrical power control method wherein each distributed power source has its own internal voltage/frequency within limits (deadband) while maintaining adequate stability and sharing of currents when paralleled.

This control method incorporates a voltage deadband and a phase angle deadband (for example +/−2.5% of setpoint) where distributed power converter output impedance is relatively high and parameter adjustable. This yields somewhat poor volt and phase regulation within deadband. When the local node (microgrid connection point) falls outside of the “deadbands” the distributed power converter output Z is rapidly diminished thereby forcing the local node to “re-enter” the deadband where currents (of parallel units) tend to be balanced and stable (appropriately damped by higher output impedance).

The phase angle deadband functions similarly with the following slight difference. When connected to the microgrid a distributed power connected source uses a PLL to synchronize to the grid. The maximum phase angle slew (deg/sec) is parameter selectable and is normally limited to 1.0 deg/sec. In the deadband control scheme the phase angle error greater than the deadband limits is detected (>+/−0.1 degree parameter adjustable). The PLL max slew rate may be increased allowing faster correction of phase angle errors and forcing phase angle at the local node within deadband.

In addition, the V_{PWM} magnitude may be adjusted and the resulting change in current out may be observed. If the change in output current is linear, it can be assumed that no grid power export is occurring. If the change in current is exponential then backfeeding of the lower impedance grid is occurring.

The circuit can be combined and tuned to allow reasonable stability under most linear and non-linear loads, although the full limits have not yet been established.

As noted herein, the PCU output impedance may be artificially increased with software, or tuned such that when two or more PCU's are run in parallel, sharing is simplified. This also tends to null any instability between one or more PCU's and the grid. Where a CBM is used, the CBM may monitor the current and voltage phase angle at the grid-connect node.

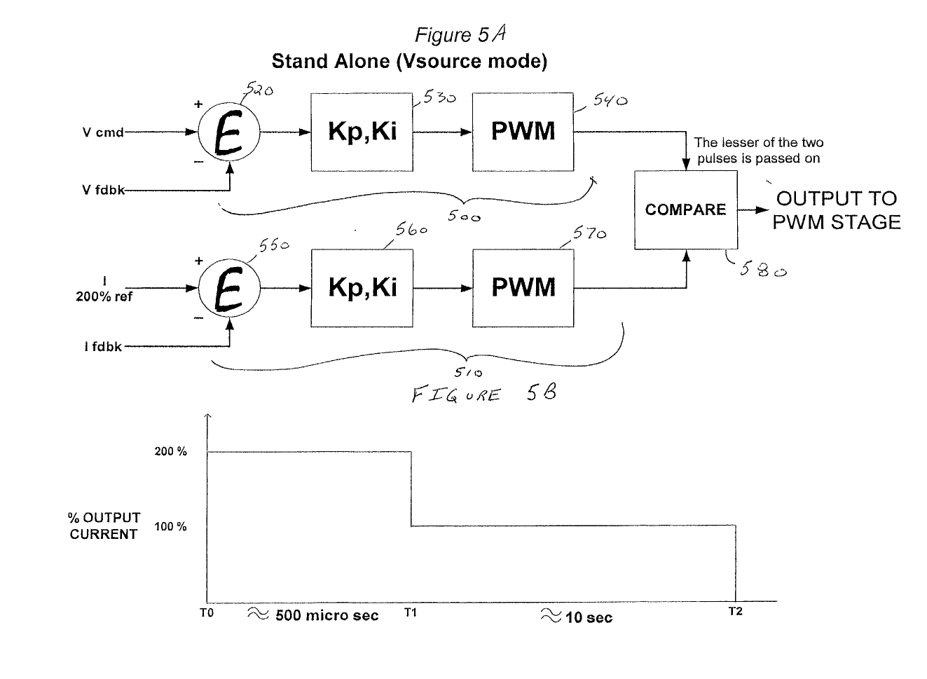

A different control loop architecture is illustrated in FIGS. 5A and 5B. In this stand-alone mode, there is a voltage loop 500 parallel to a current loop 510. When the PWM control loop is run in voltage (or stand-alone) mode, a current loop 510 is run in parallel with the voltage loop 500, and each of these loops generates a PWM output pulse pattern. A voltage command (Vcmd) signal and a voltage feedback (Vfdbk) signal are used to generate a difference or error signal 520. The error signal is amplified 530 and input to the voltage PWM section 540. A current reference (I_{200%}ref) signal and a current feedback (Ifdbk) signal are used to generate a difference or error signal 550. The error signal is amplified 560 and input to the current PWM section 570. The resultant voltage PWM signal and current PWM signal are compared 580 and the lesser of the two signals is passed on to the power stage.

This allows for an easy shift between voltage and current modes (back and forth). When the PWM is shifted into current control mode, a timer starts. Once it has reached the current limit, it is reduced to the 100% rated output. At T₂, a fault is initiated and the output pulses are terminated. At T₁, the output voltage will begin to collapse, after approximately 20 ms the limits will be violated, an optional output to the circuit breaker manager (CBM) will cause individual house branch circuits to shut down in an effort to prevent the PCU from tripping of or violating circuit limits.

I_{REF} is an adjustable current reference that is normally set to 200% of the current rating. During an overload, an adjustable timer drops the I_{REF} command to 100% of the current rating for current foldback (timer becomes active after unit shifts into current limit mode). An output to the CBM warns of the need to shed non-critical individual branch loads to prevent system shutdown.

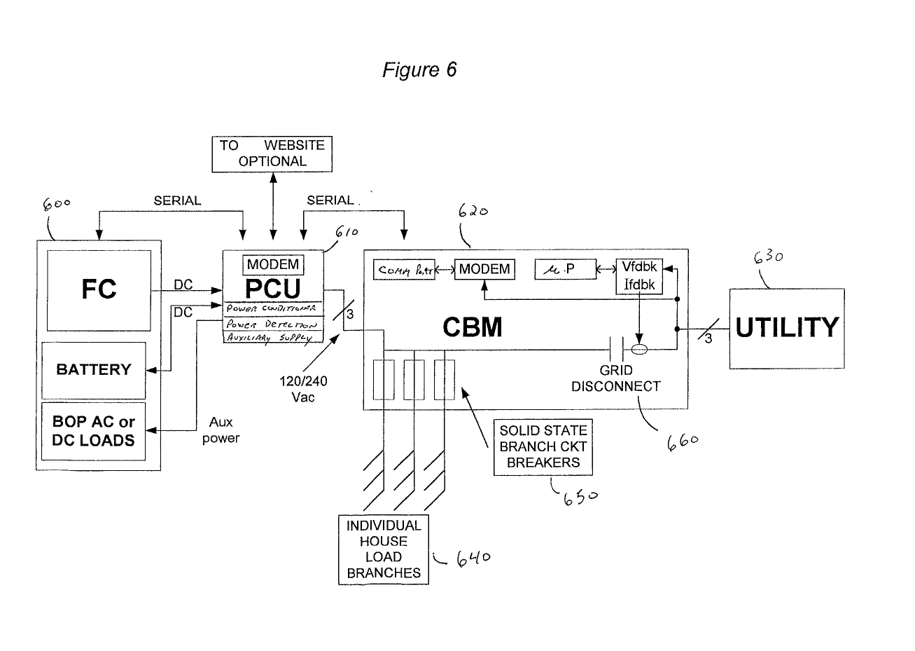

A more comprehensive configuration of the power distribution system is depicted in FIG. 6, wherein the CBM 620 allows individual branch loads 640 to be disconnected on a pre-programmed basis.

One scheme is where the CBM observes current and detects overload then shuts down the affected branch using the solid state branch circuit breakers 650. The branch circuit breakers can re-close with, or without a soft start. Another embodiment is after the CBM receives an over load notice from the PCU, it begins a programmed shutdown of overloaded or non-essential branches in an effort to shed the loads. The grid disconnect 660 is used to isolate the system from the utility grid 630. The CBM employs a microprocessor or microcontroller to manage solid state circuit breakers and serial communications.

The fuel cell unit 600 encompasses a battery as well as a balance of plant for either AC or DC loads. In one embodiment there is a serial link from the fuel cell unit to the PCU unit 610 and from the PCU 610 to the CBM 620, thus enabling communication between sections of the system. The PCU unit 610 encompasses a power conditioning unit, power detection, and auxiliary supply. A communications section, such as a modem permit communications to/from the PCU 610. The PCU can communicate to an external source such as a website or Internet controller to allow remote monitoring and control. For example, a connection to a website can allow monitoring of the electrical consumption and control the grid.

The CBM allows individual branch loads to be disconnected on a pre-programmed basis in one of two ways. Either the CBM observes current and detects overload then shuts down the affected branch and can re-close with, or without a soft start. Or, the CBM receives an over load notice from the PCU and begins a programmed shutdown of overloaded or non-essential branches in an effort to shed the load.

The serial link may be omitted and a powerline communication protocol used, in which RF signals are coupled into the actual power lines for communications between PCU, CBM, and other equipment. Embodiments include CBM interface to Blue tooth RF communications, CBM communications to house branch circuits such as appliances, computers, and lights.

The CBM modem or connection to Internet allow computers connected to branch circuits to connect with the Internet via CBM. Another embodiment allows the grid (utility) to impress a “kill” signal on to grid powerlines for shutdown/or PCU disconnect from grid commands for servicing. Such a feature can be significant feature for safety of personnel and equipment. The connectivity to the outside allows for power utilities to monitor and track the power flow in order for billing purposes as well as monitor household electronics. Employing circuit breaker switching accomplishes the same functions as smart appliances and loads on certain breakers can be controlled from the outside.

In addition, a voltage loop, or deadband, watches the grid voltage to verify it is within tolerance. If the grid voltage starts to change a “voltage/frequency tolerance warning” is detected and the system may be shut down or allowed to run. If the grid voltage error continues to increase, a “voltage/frequency tolerance fault” threshold is reached and the unit must be disconnected from the grid or shut down. It is also possible for the PCU to detect a “voltage/frequency tolerance warning” and send this warning to the CBM (circuit breaker manager) which can then disconnect from the grid and send this information back to the PCU so the PCU can shift into stand alone mode or UPS functionality.

In the stand-alone mode, the CBM continues to monitor the grid voltage. When the grid voltage comes back into tolerance, the CBM can send data to the PCU, which prepares to shift back into G/T mode by matching the grid phase angle. For this to occur, the zero crossing data must come from the CBM (which is monitoring the grid). Once synchronization has been achieved by the PCU, a serial signal is sent back to the CBM that will close back to the line. This will allow for virtually seamless switching between power sources (grid versus PCU) in both directions. Once the Close to Grid command (to the CBM disconnect contactor) is executed, a signal is sent back to the PCU to shift into G/T mode. Source switching times less than 1 cycle (16 msec) can be achieved, and refinements allow sub-cycle switching times, from G/T to stand-alone, and from stand-alone to G/T.

The CBM sync to grid will nudge the S/A voltage source frequency slightly. This will bring the stand-alone voltage into phase with the grid voltage, allowing for “quickshifting” from stand-alone to G/T mode (sub/cycle).

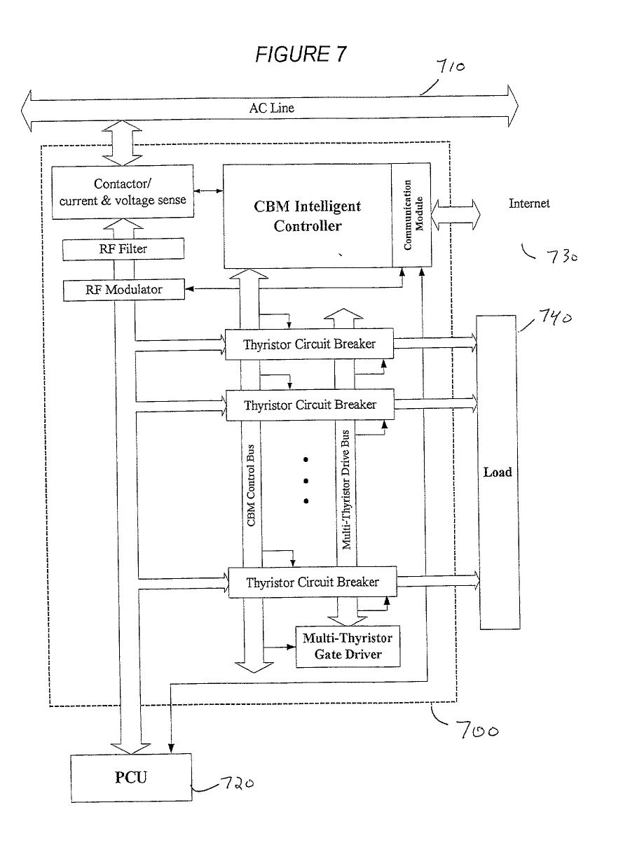

Another variation is shown in FIG. 7. The serial link is omitted in this embodiment and a powerline communication protocol used, in which RF signals that are are coupled into the actual AC power lines 710 for communications between PCU 720, CBM 700, and other equipment. Further development allow for CBM 700 interface to Blue tooth RF communications, CBM communications to house branch circuits, control of appliances, computers, and lights.

As discussed herein, the CBM 700 has a modem or connection to the Internet in to allow connectivity outside the home by the owner or others. This scheme allows computers connected to branch circuits to connect with the Internet via CBM. Grid (utility) that can impress a “kill” signal on to grid powerlines for shutdown/or PCU disconnnect from grid commands for service.

The intelligent CBM 700 comprises a controller, plurality of thyristor circuit breakers, contactors, RF filter, a RF modulator, and a multi-thyristor gate driver. The controller is a microcontroller/microprocessor that connects to all circuit breakers. The controller monitors the circuit breakers and actuates the breakers manually, remotely, or via a timing sequence. The controller opens the mechanical contactors for back feed protection if there is an outside AC line blackout or brownout. The controller closes the mechanical contactors when the outside AC line returns to normal. The controller communicates with the power site, such as a fuel cell, and other household appliances to intelligently manage the energy source. The Internet connection provides the access for billing, services, maintenance, status and adjustment/control from a remote location.

A significant drawback of silicon semiconductor based power systems as compared to “copper and steel” (transformers etc.) is their inability to provide excessive overloads or short circuit currents typically required to cause branch circuit breakers to open. To solve this problem the CBM (circuit breaker manager) employs several novel attributes.

The CBM consists of a number of branch Bi-directional solid state switches (BD-SSW's) with associated gate drive and control electronics, such as those with typical thermal overload main Circuit breaker. This provides a method where individual branch overloads can be quickly disconnected such that faults at one branch do not cause the main power source to see long duration overloads which would cause a distributed power source fault or distribution system voltage sag.

The CBM 700 employs a method where individual user selected/programmed “non-critical” branch circuits may be shed during distribution system overloads, or where power source reserve energy (or fuel) reaches a pre-selected low level and remaining energy is to be conserved for “critical branch circuits”.

The CBM 700 operates as a grid transfer switch such that the load may be connected/disconnected from the grid thereby allowing the load to be fed from the distributed power source in parallel with grid or by distributed power source alone. The CBM 700 is equipped with communication device(modem etc.) such that power flow metering may be remotely controlled for billing and other purposes. In addition, the CBM is used to detect reverse power flow (co-generation) to the grid and an error signal communicated back to the distributed power source such that distributed power source may reduce power output to limit, or prevent reverse power flow to the utility grid.

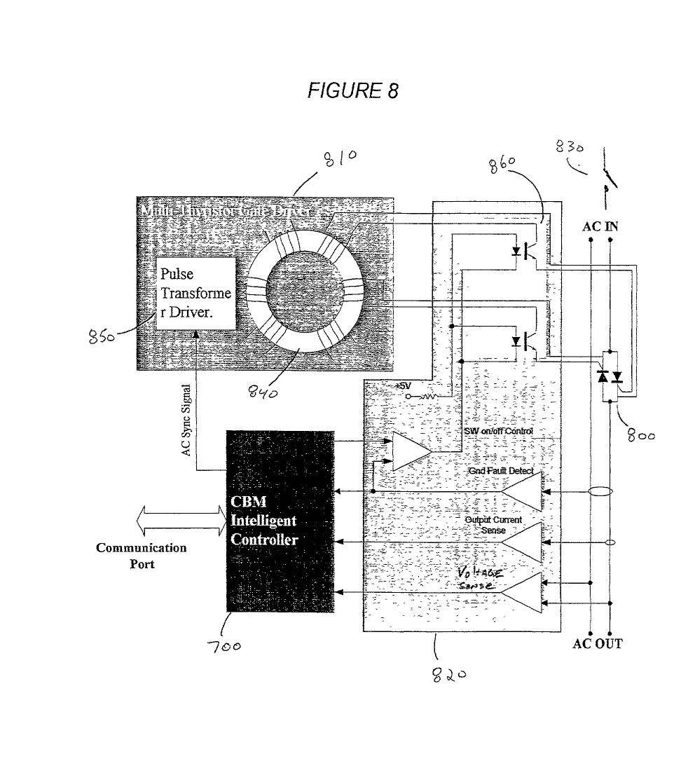

Referring to FIGS. 7 and 8, the thyristor circuit breakers of the CBM 700 are thyristor based static switch circuit breakers 800. The contactor 830 is a mechanical relay/contactor in one embodiment for connecting the AC input to the CBM.

The RF filter is used to block RF signal transmissions from interfering with circuit performance when using the AC line 710 with control signals riding on the lines. The RF modulator carries communication data between the CBM and other appliances.

The multi-thyristor gate driver 810 actuates the thyristor circuit breakers 800 by generating pulsing signals. The main components of the in the gate driver are the pulse transformer 840 and the pulse transformer driver 850. The transformer 840 includes a primary wiring and multiple secondary wiring that drives all the thyristors. The pulsing signal feeds to the circuit breaker controller 820 and connects to a small opto switch 860. As shown in FIG. 8 the switch 860 is controlled by the CBM controller to actuate the circuit breaker 800.

A current sensing circuit can be used to monitor the output current of each circuit breaker 800. For manufacturability, one or two current transformers can be built on a printed circuit board (PCB). A detect ground fault sense shows the current sensing circuit and a middle layer can be used to run the power trace and the outside layers build multiple turns trace around the center power trace.

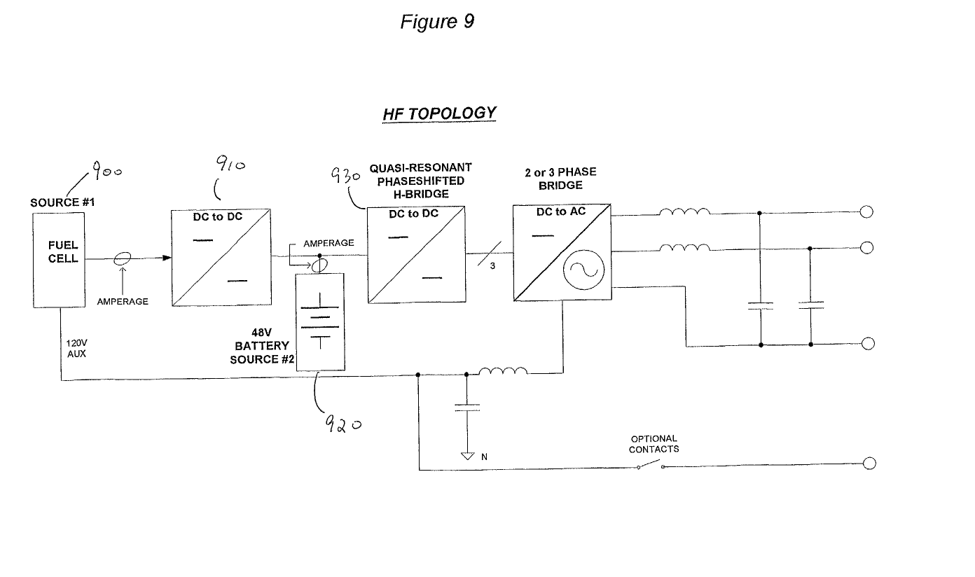

FIG. 9 is the HF topology for the distributed power system in a preferred embodiment. The topology is used for directing requisite output power ripple (120 Hz for single phase) to be sourced from either of the two input power sources (generation source and local storage source), externally insulating ripple sensitive sources from harmful effects. Thus, bulk ‘ripple-free’ power is drawn from the fuel cell while the ripple is sourced by the battery.

This system of the present invention provides reduced cost/size/weight fuel cell auxiliaries balance of plants such as pumps, compressors, motors, etc., by using 400 Hz or greater fundamental frequencies. Further, V/Hz or other soft start technologies can be used to provide added functionality (variable speed operator) and further cost reductions.

In addition, a method where the 2nd (or storage) power source may consist of a highly ripple tolerant power source, such as a flywheel, is used to provide “load required” ripple currents, as well as store bulk energy required for support of transients and overloads.

Controlling and regulating a plurality of power sources requires implementing pulse width modulation (PWM) and some form of digital signal processing (DSP). A preferred embodiment uses a transformerless output that has inductive/capacitive PWM filtering with damping resistance. Such a scheme allows excellent non-linear or unbalanced load performance, much lower cost/size/weight as opposed to a standard 60 Hz transformer.

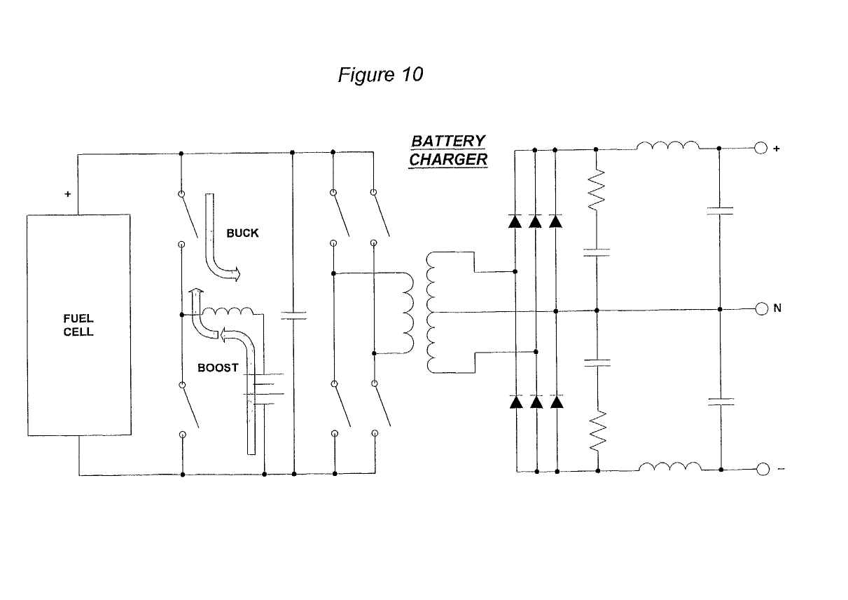

The HF topology of a 10/20 kW Fuel Cell PCU is shown in FIG. 10. As shown, the system has a battery startup to allow the fuel cell to warm up and start while providing output power. With an optional low-cost contactor to the 120V utility line, the system can be started from the grid instead of the battery. The circuitry allows for control of the input current from the fuel cell and for regulation of the battery voltage, and facilitates management of the fuel reformer.

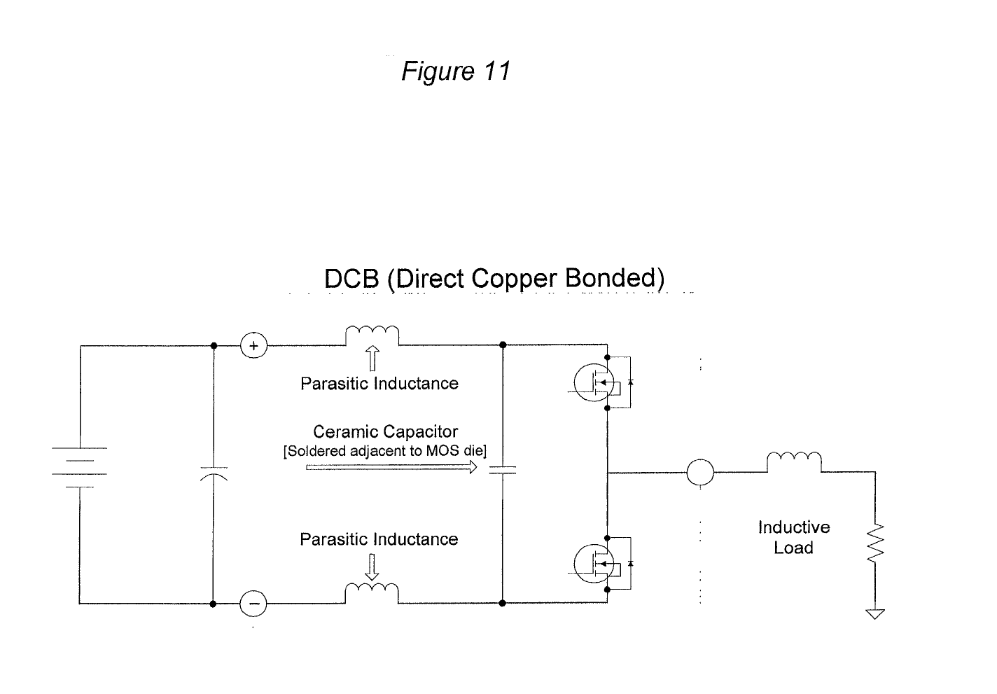

FIG. 11 illustrates a semiconductor optimization where DCB (direct copper bonded substrate) capacitors are soldered directly down to the DCB adjacent to the semiconductor MOS die to reduce effects of power circuit parasitic inductance, which allows for optimum high speed, low loss, device switching behavior.

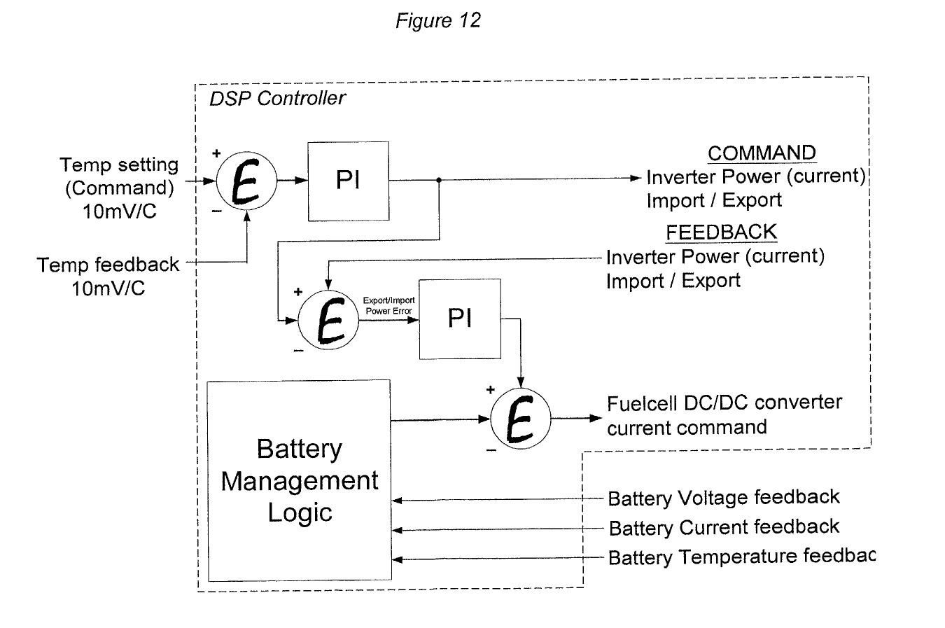

FIG. 12 is a block diagrammatic view of the control scheme. The temperature error, after amplification is sent to the inverter electrical power control loops as an “inverter power import/expert command”. The inverter control loops will attempt to obey import/export command, provided the micro grid voltage remains within the tolerance band (example±2.5%).

If the micro grid voltage (local node) drifts outside the tolerance band, the inverter electrical control loops will take over and attempt to drive the micro grid voltage back into the voltage tolerance band. If, for example, an increase in power exported to the micro grid causes the micro grid voltage to rise (outside the Voltage tolerance band) the inverter electrical control loops limit the amount of export power. In this case an export/import power error signal is developed. This error is summed into the fuel cell DC/DC converter current command thereby forcing the fuel cell to export power to the battery when export to the grid would cause the grid voltage to drift out of tolerance.

Conversely, when a “negative” temperature error is sent to the inverter control loops the inverter will export less power, (or allow import of micro grid power to feed house loads). If the micro grid voltage sags (outside the voltage tolerance band) the inverter control loops take over to export power to the grid. This action, while keeping the micro grid voltage within tolerance, will create unwanted fuel cell generated heat that must be vented, rather than recovered.

In this case a “negative” power export error is developed and is then summed into the fuel cell AC/DC converter current command. This effectively decreases the power supplied from the fuel cell and allows the battery power to provide more, or all of the power to the PCU inverter.

Thus when heat is required the fuel cell can export power to the grid and local loads, or to the battery. When heat is not desired, power may be fed from the battery to the grid, and local loads. In practice it is also likely that the entire PCU inverter may shutdown, thereby allowing the micro grid to source the local loads.

It is readily apparent that the techniques of the present invention can be used in multiple methods and implementing in a variety of manners and is not limited to the embodiments presented herein. Various variations and modifications may be made without departing from the scope of the present invention

Numerous characteristics and advantages have been set forth in the foregoing description, together with details of structures and functionality, and the novel features thereof are pointed out in appended claims. The disclosure, however, is illustrative only, and changes may be made in arrangement and details, within the principle of the invention, to the full extent indicated by the broad general meaning of the terms in which the appended claims are expressed.

The objects and advantages of the invention may be further realized and attained by means of the instrumentalities and combinations particularly pointed out in the appended claims. Accordingly, the drawing and description are to be regarded as illustrative in nature, and not as restrictive.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

No warranty is expressed or implied as to the actual degree of safety, security or support of any particular specimen of the invention in whole or in part, due to differences in actual production designs, materials and use of the products of the invention.

What is claimed is:

1. A distributed power system for a utility grid, comprising:
a distributed power source;
a temperature measuring device;
a power conditioning unit, wherein said power conditioning unit manages a power flow of said distributed power source;
a circuit breaker manager controllably connecting to said power grid, and wherein said circuit breaker manager is connected to said power conditioning unit.

2. A distributed power system for a utility grid according to claim 1, further comprising a heat exchanger for recovering heat from said distributed power source.

3. A distributed power system for a utility grid according to claim 1, wherein said circuit breaker manager controllably connects individual load branches.

4. A distributed power system for a utility grid according to claim 1, wherein said utility grid is a local area grid comprising a plurality of distributed power sources.

5. A segmentable distributed power system, comprising:
two or more power sources connected in parallel;
a power conditioning unit having an output impedance and connecting to each of said power sources on a first side and connecting to a shared load on a second side, wherein said power conditioning system controls said output impedance.

6. A circuit breaker manager for controlling distributed power between a power source and an external power grid, comprising:
a circuit breaker controller;
a plurality of solid state branch circuit breakers controlled by said circuit breaker controller;
a contactor for connecting to said external power grid;
a voltage sensor for measuring said external power grid; and
a means for communicating.

7. A local area grid device for distributed power according to claim 6, wherein said communicating means connects to the Internet.

8. A system for managing a local area grid according to claim 7, further comprising an interface means for connecting said power conditioning unit to a graphical user interface for status, billing, maintenance, and adjustment of system parameters.

9. A method for controlling a local area grid, wherein said grid contains two or more distributed power sources, comprising the steps of:
measuring a grid voltage by each power condition unit;
comparing said grid voltage of each power conditioning unit to a predetermined value;
increasing current output of said power conditioning unit to said local area grid if said grid voltage is less than said predetermined value; and
decreasing current output of said power conditioning unit to said local area grid if said grid voltage is greater than said predetermined value.

10. A distributed power system for a ripple sensitive distributed power source, comprising:
A DC-DC converter serially connecting to said ripple sensitive power source on a first side;
A ripple tolerant power source connecting to said DC-DC converter on a second side;
A phase shifted H-bridge connecting to said second side of said DC-DC converter on a first side;
A DC-AC converter connecting to a second side of said H-bridge; and
A means for forcing ripple sourced from said ripple tolerant power source.
